(19) United States
(12) Patent Application Publication
(10) Pub. No.: US 2022/0391736 A1
(43) Pub. Date: Dec. 8, 2022

(54) STOCHASTIC EVENT TRIAGE FOR ARTIFICIAL INTELLIGENCE FOR INFORMATION TECHNOLOGY OPERATIONS

(71) Applicant: International Business Machines Corporation, Armonk, NY (US)

(72) Inventors: Tsuyoshi Ide, Harrison, NY (US); Georgios Kollias, White Plains, NY (US); Dzung Tien Phan, Pleasantville, NY (US); Naoki Abe, Rye, NY (US)

(21) Appl. No.: 17/303,828

(22) Filed: Jun. 8, 2021

(51) Int. Cl. G06N 7/00; G06N 20/00; G06F 17/16

(52) U.S. Cl. CPC G06N 7/005; G06N 20/00; G06F 17/16

(57) ABSTRACT

A computer-implemented method, a computer program product, and a computer system for stochastic event triage. A computer receives an event log including timestamps and event types. The computer determines a sparse impact matrix representing causal relationships between the event types, via a cardinality regularization. The computer determines triggering probabilities representing causal association probabilities between individual event instances, by leveraging a variational bound of a likelihood function. The computer provides a user with the triggering probabilities for event triage. The computer learns model parameters by iterating type-level causal analysis and instance-level causal analysis.

### BACKGROUND

The present invention relates generally to stochastic event triage for artificial intelligence for information technology operations (AIOps), and more particularly to a framework not only learning causal relationships between event types but also determining causal association probabilities between event instances.

Event triage, often on “alert” events, refers to the task of prioritizing numerous events to produce a short list of important events. A critical sub-task towards this goal is that of identifying and prioritizing temporal event instances that are causally related to an event of interest.

Modeling time-stamped events using point processes is an emerging research topic in machine learning (ML) gaining considerable recent interest. Unlike mainstream ML problems on independent and identically distributed (i.i.d.) vector data, they require treatment of individual events as stochastic objects without aggregation. The Hawkes process, in particular, is a popular point process model used in this context (Hawkes, Spectra of some self-exciting and mutually exciting point processes, Biometrika, Vol. 58, 1971). In the ML literature, there have been two major milestones in the studies of Hawkes processes to date. One is the minorization-maximization (MM) algorithm (Hunter et al., A tutorial on MM algorithms, The American Statistician, 58(1), 2004) and the other is Granger causal discovery through Hawkes processes (Granger, Investigating causal relations by econometric models and cross-spectral methods, Econometrica, 37(3), 1969).

The first milestone is marked by Veen and Schoenberg (Estimation of space-time branching process models in seismology using an EM-type algorithm, Journal of the American Statistical Association, 103(482), 2008). Based on the intuition of branching process of earthquake aftershocks, they introduce the first MM-based maximum likelihood algorithm, which is often loosely called EM (expectation-maximization) due to their similarity (Neal et al., A view of the EM algorithm that justifies incremental, sparse, and other variants, Learning in graphical models, 1998). The standard gradient-based maximum likelihood estimation (MLE) of multivariate Hawkes processes suffers from numerical stability issues, limiting their applicability in practice. The second milestone is achieved by a few pioneering works in Hawkes-based Granger causal modeling. Kim et al. (A Granger causality measure for point process models of ensemble neural spiking activity, PLoS Comput Biol, 7(3), 2011) proposes Hawkes-based causal learning. Zhou et al. (Learning social infectivity in sparse low-rank networks using multi-dimensional Hawkes processes, Proceedings of the 16th International Conference on Artificial Intelligence and Statistics, 2013) introduces I₁ regularization in MLE of a multivariate Hawkes process. Eichler et al. (Graphical modeling for multivariate Hawkes processes with nonparametric link functions, arXiv:1605.06759v1, 2016) theoretically establishes the equivalence between Hawkes-based causality and the Granger causality.

Given these achievements and the well-known importance of sparsity in Granger causal learning (Arnold et al., Temporal causal modeling with graphical Granger methods. In Proc. ACM SIGKDD, 2007; Lozano et al., Grouped graphical granger modeling for gene expression regulatory networks discovery, Bioinformatics, 2009 2009), the MM algorithm combined with a sparsity-enforcing regularizer would seem to be a promising path for a solid solution. Interestingly, however, the likelihood function of the MM algorithm has a singularity that in fact prohibits any sparse solutions. Despite its significance, to date little attention has been paid to this issue in the ML community.

### SUMMARY

In one aspect, a computer-implemented method for stochastic event triage is provided. The computer-implemented method includes receiving an event log, where the event log includes timestamps and event types. The computer-implemented method further includes determining a sparse impact matrix representing causal relationships between the event types, via a cardinality regularization. The computer-implemented method further includes determining triggering probabilities representing causal association probabilities between individual event instances, by leveraging a variational bound of a likelihood function. The computer-implemented method further includes providing a user with the triggering probabilities for event triage.

The computer-implemented method for stochastic event triage further includes determining baseline intensities of respective ones of the event types, where the baseline intensities provide information about how each of the event types has a tendency of occurring on its own without any triggering event. The computer-implemented method further includes determining decay rates of the respective ones of the event types, wherein the decay rates provide information about time scales of the respective ones of the event types.

The computer-implemented method for stochastic event triage further includes learning model parameters by iterating type-level causal analysis and instance-level causal analysis. The type-level causal analysis includes determining the sparse impact matrix, the baseline intensities of respective ones of the event types, and the decay rates of respective ones of the event types. The instance-level causal analysis includes determining the triggering probabilities.

The computer-implemented method for stochastic event triage further includes generating initial triggering probabilities. The computer-implemented method further includes computing the baseline intensities, the decay rates, and the sparse impact matrix, based on the initial triggering probabilities.

The computer-implemented method for stochastic event triage further includes updating, in a current round of computation, the triggering probabilities, based on the baseline intensities, the decay rates, and the sparse impact matrix computed in a previous round of computation. The computer-implemented method further includes updating the baseline intensities, the decay rates, and the sparse impact matrix, based on the triggering probabilities that have been updated. The computer-implemented method further includes, in response to determining that the baseline intensities, the decay rates, and the sparse impact matrix converge, outputting the triggering probabilities that have been updated in the current round of computation. The computer-implemented method further includes, in response to determining that the baseline intensities, the decay rates, and the sparse impact matrix do not converge, iterating updating the triggering probabilities, the baseline intensities, the decay rates, and the sparse impact matrix.

In another aspect, a computer program product for stochastic event triage is provided. The computer program product comprises a computer readable storage medium having program instructions embodied therewith, and the program instructions are executable by one or more processors. The program instructions are executable to: receive an event log including timestamps and event types; determine a sparse impact matrix representing causal relationships between the event types, via a cardinality regularization; determine triggering probabilities representing causal association probabilities between individual event instances, by leveraging a variational bound of a likelihood function; and provide a user with the triggering probabilities for event triage.

In the computer program product for stochastic event triage, the program instructions are further executable to determine baseline intensities of respective ones of the event types, wherein the baseline intensities provide information about how each of the event types has a tendency of occurring on its own without any triggering event. The program instructions are further executable to determine decay rates of the respective ones of the event types, wherein the decay rates provide information about time scales of the respective ones of the event types.

In the computer program product for stochastic event triage, the program instructions are further executable to learn model parameters by iterating type-level causal analysis and instance-level causal analysis, where the type-level causal analysis includes determining the sparse impact matrix, the baseline intensities of respective ones of the event types, and the decay rates of respective ones of the event types, where the instance-level causal analysis includes determining the triggering probabilities.

In the computer program product for stochastic event triage, the program instructions are further executable to generate initial triggering probabilities. The program instructions are further executable to compute the baseline intensities, the decay rates, and the sparse impact matrix, based on the initial triggering probabilities.

In the computer program product for stochastic event triage, the program instructions are further executable to: update, in a current round of computation, the triggering probabilities, based on the baseline intensities, the decay rates, and the sparse impact matrix computed in a previous round of computation; update the baseline intensities, the decay rates, and the sparse impact matrix, based on the triggering probabilities that have been updated; in response to determining that the baseline intensities, the decay rates, and the sparse impact matrix converge, output the triggering probabilities that have been updated in the current round of computation; and in response to determining that the baseline intensities, the decay rates, and the sparse impact matrix do not converge, iterate updating the triggering probabilities, the baseline intensities, the decay rates, and the sparse impact matrix.

In yet another aspect, a computer system for stochastic event triage is provided. The computer system comprises one or more processors, one or more computer readable tangible storage devices, and program instructions stored on at least one of the one or more computer readable tangible storage devices for execution by at least one of the one or more processors. The program instructions are executable to receive an event log including timestamps and event types. The program instructions are further executable to determine a sparse impact matrix representing causal relationships between the event types, via a cardinality regularization. The program instructions are further executable to determine triggering probabilities representing causal association probabilities between individual event instances, by leveraging a variational bound of a likelihood function. The program instructions are further executable to provide a user with the triggering probabilities for event triage.

In the computer system for stochastic event triage, the program instructions are further executable to: determine baseline intensities of respective ones of the event types, wherein the baseline intensities provide information about how each of the event types has a tendency of occurring on its own without any triggering event; and determine decay rates of the respective ones of the event types, wherein the decay rates provide information about time scales of the respective ones of the event types.

In the computer system for stochastic event triage, the program instructions are further executable to learn model parameters by iterating type-level causal analysis and instance-level causal analysis. The type-level causal analysis includes determining the sparse impact matrix, the baseline intensities of respective ones of the event types, and the decay rates of respective ones of the event types. The instance-level causal analysis includes determining the triggering probabilities.

In the computer system for stochastic event triage, the program instructions are further executable to: generate initial triggering probabilities; and compute the baseline intensities, the decay rates, and the sparse impact matrix, based on the initial triggering probabilities.

In the computer system for stochastic event triage, the program instructions are further executable to update, in a current round of computation, the triggering probabilities, based on the baseline intensities, the decay rates, and the sparse impact matrix computed in a previous round of computation. The program instructions are further executable to update the baseline intensities, the decay rates, and the sparse impact matrix, based on the triggering probabilities that have been updated. The program instructions are further executable to, in response to determining that the baseline intensities, the decay rates, and the sparse impact matrix converge, output the triggering probabilities that have been updated in the current round of computation. The program instructions are further executable to, in response to determining that the baseline intensities, the decay rates, and the sparse impact matrix do not converge, iterate updating the triggering probabilities, the baseline intensities, the decay rates, and the sparse impact matrix.

In yet another aspect, a computer-implemented method for learning model parameters in stochastic event triage is provided. The computer-implemented method includes updating baseline intensities of respective ones of event types, based on triggering probabilities, where the baseline intensities provide information about how each of the event types has a tendency of occurring on its own without any triggering event, where the triggering probabilities represent causal association probabilities between individual event instances. The computer-implemented method further includes updating decay rates of the respective ones of the event types, based on the triggering probabilities, where the decay rates provide information about time scales of the respective ones of the event types. The computer-implemented method further includes updating a sparse impact matrix, based on the triggering probabilities, where the sparse impact matrix represents causal relationships between the event types. The computer-implemented method further includes updating the triggering probabilities, based on the baseline intensities, the decay rates, and the sparse impact matrix. The computer-implemented method further includes providing a user with the triggering probabilities for event triage, in response to determining that the baseline intensities, the decay rates, and the sparse impact matrix converge.

The computer-implemented method for learning model parameters in stochastic event triage further includes receiving predetermined constants for regularization strength. The computer-implemented method further includes generating initial triggering probabilities. The computer-implemented method further includes computing the baseline intensities, the decay rates, and the sparse impact matrix, based on the initial triggering probabilities.

The computer-implemented method for learning model parameters in stochastic event triage further includes, in response to determining that the baseline intensities, the decay rates, and the sparse impact matrix do not converge, iterating updating the baseline intensities, the decay rates, the sparse impact matrix converge, and the triggering probabilities.

In yet another aspect, a computer program product for learning model parameters in stochastic event triage is provided. The computer program product comprises a computer readable storage medium having program instructions embodied therewith, and the program instructions are executable by one or more processors. The program instructions are executable to: update baseline intensities of respective ones of event types, based on triggering probabilities, where the baseline intensities provide information about how each of the event types has a tendency of occurring on its own without any triggering event, where the triggering probabilities represent causal association probabilities between individual event instances; update decay rates of the respective ones of the event types, based on the triggering probabilities, where the decay rates provide information about time scales of the respective ones of the event types; update a sparse impact matrix, based on the triggering probabilities, where the sparse impact matrix represents causal relationships between the event types; update the triggering probabilities, based on the baseline intensities, the decay rates, and the sparse impact matrix; and provide a user with the triggering probabilities for event triage, in response to determining that the baseline intensities, the decay rates, and the sparse impact matrix converge.

In the computer program product for learning model parameters in stochastic event triage, the program instructions are further executable to: receive predetermined constants for regularization strength; generate initial triggering probabilities; and compute the baseline intensities, the decay rates, and the sparse impact matrix, based on the initial triggering probabilities.

In the computer program product for learning model parameters in stochastic event triage, the program instructions are further executable to, in response to determining that the baseline intensities, the decay rates, and the sparse impact matrix do not converge, iterate updating the baseline intensities, the decay rates, the sparse impact matrix converge, and the triggering probabilities.

### BRIEF DESCRIPTION OF THE SEVERAL VIEWS OF THE DRAWINGS

FIG. 1(A) and FIG. 1(B) illustrate two main outcomes of a proposed framework in the present invention, triggering probabilities and an impact matrix, in accordance with one embodiment of the present invention.

FIG. 2 illustrates intensity functions and decay functions for different event types, in accordance with one embodiment of the present invention.

FIG. 3 illustrates an overall computational procedure of a proposed framework in the present invention, in accordance with one embodiment of the present invention.

FIG. 4 presents a flowchart showing operational steps of learning model parameters and determining triggering probabilities based on the model parameters, in accordance with one embodiment of the present invention.

FIG. 5(A), FIG. 5(B), and FIG. 5(C) present comparison of sparsity patterns of impact matrix A estimated by a proposed framework in the present invention and existing approaches in the art.

FIG. 6(A) presents non-zero elements of triggering probabilities, in accordance with one embodiment of the present invention.

FIG. 6(B) presents triggering probabilities for a 150th instance, in accordance with one embodiment of the present invention.

FIG. 7 is a diagram illustrating components of a computing device or server, in accordance with one embodiment of the present invention.

FIG. 8 depicts a cloud computing environment, in accordance with one embodiment of the present invention.

FIG. 9 depicts abstraction model layers in a cloud computing environment, in accordance with one embodiment of the present invention.

### DETAILED DESCRIPTION

Embodiments of the present invention propose a unified approach to a problem, in which not only is causal relationships between the various event types learned but also causal association probabilities between individual event instances are determined. For the former, embodiments of the present invention develop a cardinality regularization technique in fitting multivariate Hawkes processes. This achieves causal estimation that is both accurate and sparse thus helping to enable effective event consolidation. For the latter, a framework proposed in the present invention leverages the variational bound of a likelihood function for discovering the causal association probabilities, thereby achieving simultaneous instance- and type-level causal analysis.

Embodiments of the present invention provide a mathematically well-defined solution to sparse causality learning for event data, especially in the context of what we call event triage. For concreteness, consider a use case of cloud data center management. Various computer devices continuously produce numerous event logs. Due to interconnectivity of the devices, one warning event from one device, such as “response time too long,” may trigger many related events in downstream services. The more critical the original error is, the more redundant the resulting set of events tends to be. Event triage, or the act of shortlisting high priority events, demands as prerequisite the task of associating and consolidating causally related event instances. Note that this requires instance-specific causal relationships for precise judgement. Even if, for instance, the i-th event type is on average likely to have a causal relationship with the j-th type, one specific instance of the i-th event type may have occurred spontaneously. A practical solution for event triage must therefore perform type- and instance-level causal analysis simultaneously, while adequately handling the stochastic nature of events. Despite the prevalence of the “warning fatigue” issue across many industries (Elshoush et al, Alert correlation in collaborative intelligent intrusion detection systems—A survey. Applied Soft Computing, 2011; Moyne et al., Big data analytics for smart manufacturing: Case studies in semiconductor manufacturing, Processes, 2017; Dominiak et al., Prioritizing alarms from sensor-based detection models in livestock production— A review on model performance and alarm reducing methods, Computers and Electronics in Agriculture, 2017), to date limited work has been done that leverages stochastic event causal modeling in this context.

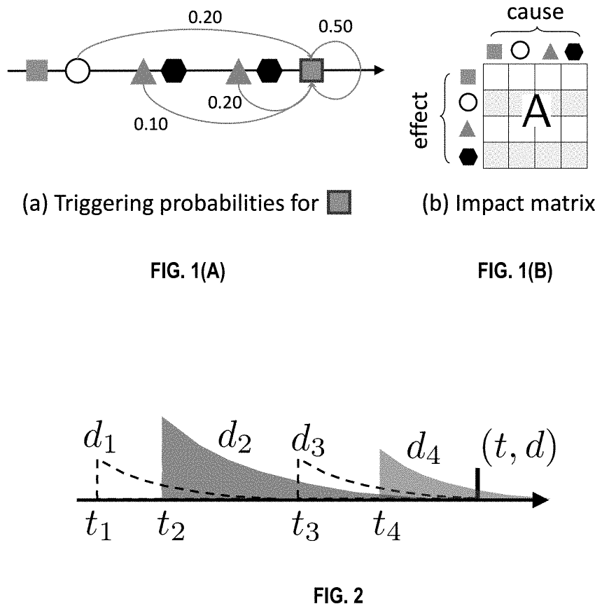

Embodiments of the present invention propose a novel framework for event triage grounded on a new cardinality-regularized MM algorithm. Unlike existing l₁-regularization and l_{2,1}-regularization approaches (Zhou et al., 2013; Xu et al., Learning Granger causality for Hawkes processes, In Proc. International conference on machine learning, 2016), it is free from pathological issues due to the logarithmic singularity at zero and realizes mathematically well-defined sparsity. The framework proposed in the present invention leverages the variational bound of the MM algorithm for discovering instance-level causal association, thereby achieving simultaneously instance- and type-level causal learning, as illustrated in FIG. 1(A) and FIG. 1(B). FIG. 1(A) and FIG. 1(B) illustrate two main outcomes of the proposed framework, respectively: (1) triggering probabilities quantify instance-wise causal relationship for event triage, and (2) impact matrix represents Granger causality among event types/classes.

Next paragraphs provide a problem setting and recapitulates the basics of stochastic point processes.

Problem Setting:

We are given an event sequence of N+1 event instances:

[symbol]

={(t₀,d₀),(t₁,d₁), . . . ,(t_{N},d_{N})}, (1)

where tₙ and dₙ are the timestamp and the event type of the n-th event, respectively. The timestamps have been sorted in non-decreasing order t₀≤t₁≤ . . . ≤t_{N}. There are D event types {1, 2, . . . , D} with D<<N. The first time stamp t₀ is taken as the time origin. Hence, the remaining N instances are thought of as realization of random variables, given d₀. As a general rule, we use t or u as a free variable representing time while those with a subscript denote an instance.

The main goal of event triage is to compute the instance triggering probabilities {q_{n,i}}, where g_{n,i} is the probability for the n-th event (n=1, . . . , N) instance to be triggered by the i-th event (i=0, n). By definition, n≥i, and

$$\begin{matrix}{\sum }_{i = 0}^{n} {q}_{n , i} = 1 , & ∀ n ∈ \{ 1 , ... , N \}\end{matrix} . \qquad ( 2 )$$

q_{n,n} is called the self triggering (or simply self) probability. Note that providing the instance triggering probabilities {q_{n,i}} amounts to providing weighted ranking of candidates, in which the weights sum to one. It is desired to have as few candidates as possible with the aid of sparse causal learning.

Event triage in practice is primarily an unsupervised learning task. One typical use-case is event filtering as an enhancement of an existing monitoring system. For example, the end-user can be a sysadmin managing a computer system. From an external information source (such as a complaint call from a customer), the sysadmin realizes that there is something wrong in the system, and then the sysadmin checks the triggering probabilities for an event of interest.

Likelihood of Correlated Events:

Since all the events are supposed to be correlated, the most general probabilistic model is the joint distribution of the N events. By the chain rule of probability density functions (pdf), the joint distribution can be represented as

$$f ( ( {t}_{1} , {d}_{1} ) , … , ( {t}_{N} , {d}_{N} ) \vert ( {t}_{0} , {d}_{0} ) ) = {\prod }_{n = 1}^{N} f ( {t}_{n} , {d}_{n} \vert {ℋ}_{n - 1} ) , \qquad ( 3 )$$

where [symbol] ₙ₋₁ denotes the event history up to tₙ₋₁, namely,

[symbol]

ₙ₋₁ [symbol] {(t₀,d₀),(t₁,d₁), . . . ,(t_{N-1},d_{N-1})}. (4)

We use f(·) to symbolically denote a pdf. This decomposition readily leads to the definition of the base likelihood function L₀:

$${L}_{0} = Δ {\sum }_{n = 1}^{N} \{ ln f ( {t}_{n} \vert {d}_{n} , {ℋ}_{n - 1} ) + ln f ( {d}_{n} \vert {ℋ}_{n - 1} ) \} . \qquad ( 5 )$$

The distribution f(tₙ|dₙ, [symbol] ₙ₋₁) is defined on tₙ₋₁≤t<∞ and satisfies the normalization condition in the domain.

For the task of event triage, the first term in the summation of equation (5) plays the central role. We omit the second term in the summation, assuming that f (dₙ| [symbol] ₙ₋₁) is a constant.

Intensity Function:

Given [symbol] ₙ₋₁, the intensity function is defined as the probability density that the first event since tₙ₋₁ occurs. This is a conditional density. When considering the density at t, the condition reads “no event occurred in [tₙ₋₁, t).” Hence,

$${λ}_{d} ( t \vert {ℋ}_{n - 1} ) {=}^{△} \frac{f ( t \vert d , {ℋ}_{n - 1} )}{1 - {\int }_{{t}_{n - 1}}^{t} duf ( u \vert d , {ℋ}_{n - 1} )} , \qquad ( 6 )$$

where λ_{d} (t [symbol] ₙ₋₁) is the intensity function for d-th event type, given the history [symbol] ₙ₋₁. Note that the right hand side of equation (6) can be written as

$$- \frac{d}{dt} ln ( 1 - {\int }_{{t}_{n - 1}}^{t} duf ( u \vert d , {ℋ}_{n - 1} ) ) . \qquad ( 7 )$$

Integrating the both sides of equation (6) and arranging the terms, we obtain

$$f ( t \vert d , {ℋ}_{n - 1} ) = {λ}_{d} ( t \vert {ℋ}_{n - 1} ) {e}^{- {\int }_{{t}_{n - 1}}^{t} du {λ}_{d} ( u \vert {ℋ}_{n - 1} )} , \qquad ( 8 )$$

which allows representing L₀ in terms of the intensity:

$${L}_{0} = {\sum }_{n = 1}^{N} \{ ln {λ}_{{d}_{n}} ( {t}_{n} \vert {ℋ}_{n - 1} ) + {\int }_{{t}_{n - 1}}^{{t}_{n}} du {λ}_{{d}_{n}} ( u \vert {ℋ}_{n - 1} ) \} . \qquad ( 9 )$$

Notice the dependency of the event intervals on n in the second term. When D>1, the summation over n cannot be performed in the second term due to do being dependent on n. This fact is sometimes incorrectly ignored in the literature.

Next paragraphs provide a specific model for the intensity function and introduce the instance triggering probabilities {q_{n,i}}.

Intensity Function and Granger Causality:

Equations (6) and (9) hold for any point process. Here, we introduce a specific parameterization of the Hawkes process:

$${λ}_{d} ( t \vert {ℋ}_{n - 1} ) = {μ}_{d} + {\sum }_{i = 0}^{n - 1} {A}_{d , {d}_{i}} {ϕ}_{d} ( t - {t}_{i} ) , \qquad ( 10 )$$

where μ_{d}≥0 is called the baseline intensity of the d-th type, A_{d,d}_{ᵢ} is the (d, dᵢ)-element of the impact matrix A∈ [symbol] ^{D×D} and ϕ_{d}(t−tᵢ) is the decay function of the d-th type. The baseline intensity (μ_{d}) gives information on how the d-th event type has the tendency of occurring on its own without any triggering events. The impact matrix A gives causal relationships between event types. The impact matrix A is also known as the kernel or triggering matrix. Popular choices for ϕ_{d} are the exponential and power distributions. For the exponential distribution,

$${ϕ}_{d} ( u ) {=}^{△} {β}_{d} {e}^{- {β}_{d} u} , \qquad ( 11 )$$

and for the power distribution,

$${ϕ}_{d} ( u , η ) {=}^{△} \frac{η {β}_{d}}{{( 1 + {β}_{d} u )}^{η + 1}} , \qquad ( 12 )$$

where β_{d}≥0 is called the decay rate of the d-th type and it gives information about the time scale of the d-th event type, and η>1 is a hyperparameter. The reciprocal 1/β_{d} can be called the effective window size of the d-the event type. For later use, we also define the non-dimensional version as:

$$φ ( u ) {=}^{△} \frac{1}{{β}_{d}} {ϕ}_{d} ( \frac{u}{{β}_{d}} ) . \qquad ( 13 )$$

FIG. 2 illustrates equation (10), in which λ_{d} (t [symbol] ₄)) is shown with a exponential distribution ϕ_{d}. We assume that A_{d,d}_{₁}=A_{d,d}_{₃}=0 and A_{d,d}_{₂}>A_{d,d}_{₄}. The effect of the 2nd instance is larger than that of the 4th due to time decay despite the larger A_{d,d}_{₂}. On the other hand, as shown with the dashed lines, the 1st and 3rd event instances have no effect on the occurrence probability for the assumed d-th event type in any future time point. This is in fact how Eichler et al. (2016) defined the Granger non-causality in the Hawkes model (see also Achab et al., Uncovering causality from multivariate Hawkes integrated cumulants, Journal of Machine Learning Research, 18, 2018). Specifically, if the existence of event instances of the d′-type in the past has no effect on the event occurrence probability of the d-th type, then the d′-th type is a Granger non-cause of the d-th type. The additive form of equation (10) has a clear advantage in terms of connection to Granger causality. The impact matrix A represents Granger causality. For this reason, introducing dependency on dₖ into the decay function can be redundant.

Introducing Triggering Probability:

As shown in FIG. 2, achieving sparsity in the impact matrix A is of critical importance in event triage. It directly leads to reducing the number of event candidates to be consolidated. To guarantee sparsity, we propose the following cardinality-regularized maximum likelihood:

$${max}_{A , μ , β} \{ {L}_{0} ( A , μ , β ) - τ {‖ A ‖}_{0} - {R}_{2} ( A , μ , β ) \} , \qquad ( 14 )$$

$${R}_{2} ( A , μ , β ) {=}^{△} \frac{1}{2} ( {v}_{μ} {‖ μ ‖}_{2}^{2} + {v}_{β} {‖ β ‖}_{2}^{2} + {v}_{A} {‖ A ‖}_{F}^{2} ) , \qquad ( 15 )$$

where ∥A∥₀ is the cardinality of A, i.e., the number of nonzero elements, ∥·∥₂ is the 2-norm and ∥·∥_{F} is the Frobenius norm. Also, β [symbol] (β₁, . . . , β_{D})^{T} and μ [symbol] (μ₁, . . . , μ_{D})^{T}. β represents decay rates of respective ones of the D event types {1, 2, . . . , D} and it gives information about the time scales of the respective ones of the D event types. μ represents the baseline intensities of the respective ones of the D event types {1, 2, . . . , D} and it gives information about how each of the D event types has the tendency of occurring on its own without any triggering events. τ, v_{β}, v_{μ}, and v_{A} are constants for regularization strength.

Numerically solving for maximum likelihood estimation (MLE) is known to be challenging even when τ=0, mainly due to the nonlinear logarithmic term in equation (9). The minorization-maximization (MM) algorithm leverages the additive structure of the Hawkes process in equation (10) to apply Jensen's inequality in a manner similar to the expectation-maximization (EM) algorithm for mixture models (Neal et al., 1998). Specifically, we first rewrite equation (10) as

$${λ}_{{d}_{n}} ( {t}_{n} \vert {ℋ}_{n - 1} ) = {\sum }_{i = 0}^{n} {Φ}_{n , i}^{{d}_{n} , {d}_{i}} , \\ where \qquad ( 16 )$$

$${Φ}_{n , i}^{{d}_{n} , {d}_{i}} {=}^{△} \{ \begin{matrix}{μ}_{{d}_{n}} , & i = n \\ {A}_{{d}_{n} , {d}_{i}} {ϕ}_{d} ( {t}_{n} - {t}_{i} ) , & i = 0 , … , n - 1\end{matrix} . \qquad ( 17 )$$

With an arbitrary distribution q_{n,i} over i such that Σᵢ₌₀ⁿq_{n,i}=1, for ∀n, Jensen's inequality guarantees

$$ln {\sum }_{i = 0}^{n} {Φ}_{n , i}^{{d}_{n} , {d}_{i}} \geq {\sum }_{i = 0}^{n} {q}_{n , i} ln \frac{{Φ}_{n , i}^{{d}_{n} , {d}_{i}}}{{q}_{n , i}} . \qquad ( 18 )$$

The tightest bound is obtained by maximizing the right hand side of the equation with respect to q_{n,i} under the normalization condition:

$${q}_{n , i} = \{ \begin{matrix}{{λ}_{{d}_{n}} ( {t}_{n} \vert {ℋ}_{n - 1} )}^{- 1} {μ}_{{d}_{n}} , & i = n \\ {{λ}_{{d}_{n}} ( {t}_{n} \vert {ℋ}_{n - 1} )}^{- 1} {A}_{{d}_{n} , {d}_{i}} {ϕ}_{{d}_{n}} ( t - {t}_{i} ) , & i \neq n\end{matrix} . \qquad ( 19 )$$

Although q_{n,i} was introduced as a mathematical artifact in Jensen's inequality, it opens a new door to instance-level causal analysis. We interpret q_{n,i} as the instance triggering probability that the n-th instance has been triggered by the i-th instance. The i-th instance has a higher triggering probability when (1) it is closer to the n-th instance and (2) its event type dᵢ is more causally related to that of the n-th instance.

Note that equation (19) achieves soft and adaptive windowing in event consolidation. One standard approach to instance-level causal discovery in the literature is “hard-windowing” (e.g., Lin et al., Microscope: Pinpoint performance issues with causal graphs in micro-service environments, International Conference on Service-Oriented Computing, 2018), meaning that event instances are causally associated if they occurred within the same time window of a given size. In real applications, it is common that different event types have different time scales of influence, and manually tuning the window sizes can be a difficult task.

Learning Model Parameters:

We leverage the inequality (18) for parameter estimation. Now the likelihood function is lower-bounded as:

$${L}_{0} \geq {L}_{1} {=}^{△} {\sum }_{n = 1}^{N} \{ {\sum }_{i = 0}^{n} {q}_{n , i} ln \frac{{Φ}_{n , i}^{{d}_{n} , {d}_{i}}}{{q}_{n , i}} - {μ}_{{d}_{n}} {Δ}_{n , n - 1} - {\sum }_{i = 0}^{n - 1} {A}_{{d}_{n} , {d}_{i}} {ϕ}_{d} {h}_{n , i} \} , \qquad ( 20 )$$

where we define Δ_{n,i} and h_{n,i} as follows:

$${Δ}_{n , i} {=}^{△} {t}_{n} - {t}_{i} , \qquad ( 21 )$$

$${h}_{n , i} {=}^{△} {\int }_{{Δ}_{n - 1 , i}}^{{Δ}_{n , i}} du {ϕ}_{{d}_{n}} ( u ) \qquad ( 22 )$$

Although the instance triggering probabilities {q_{n,i}} depends on unknown model parameters, it is supposed that they have been obtained numerically somehow. The MM algorithm repeats the estimation of {q_{n,i}} and (μ, β, A) alternately. If we define

L [symbol] L₁−Σ∥A∥₀−R₂, (23)

the whole procedure can be concisely summarized as

μ,β,A=arg max L,given {q_{n,i}}, (24)

{q_{n,i}}=(equation (19)),given μ,β,A. (25)

Next paragraphs provides detail of parameter estimation procedure for the baseline intensity μ, the decay rate β, and the impact matrix A.

Estimation of the Baseline Intensity μ:

Now let us consider the maximum likelihood solution for μ, assuming we have a numerical estimate for {q_{n,i}}. The condition of optimality is

$$\frac{\partial L}{\partial {μ}_{k}} = 0 ,$$

where

$$\frac{\partial L}{\partial {μ}_{k}} = {\sum }_{n = 1}^{N} {δ}_{{d}_{n} , k} \{ \frac{{q}_{n , n}}{{μ}_{k}} - {Δ}_{n , n - 1} \} - {v}_{μ} {μ}_{k} , \qquad ( 26 )$$

with δ_{d}_{ₙ}_{,k} being Kronecker delta. If we define

$${D}_{k}^{μ} = {\sum }_{n = 1}^{N} {δ}_{{d}_{n} , k} {Δ}_{n , n - 1} , \qquad ( 27 )$$

$${N}_{k}^{μ} = {\sum }_{n = 1}^{N} {δ}_{{d}_{n} , k} {q}_{n , n} , \qquad ( 28 )$$

equation (26) is reduced to a simple quadratic equation

v_{μ}μₖ²+Dₖ^{μ}μₖ−Nₖ^{μ}=0, (29)

from which we have the solution

$${μ}_{k} = \frac{1}{2 {v}_{μ}} ( - {D}_{k}^{μ} + \sqrt{{( {D}_{k}^{μ} )}^{2} + 4 {v}_{μ} {N}_{k}^{μ}} ) . \qquad ( 30 )$$

Estimation of the Decay Rate β:

Next, for β, the derivative is given by

$$\frac{\partial L}{\partial {β}_{k}} = {\sum }_{( n , i )} \{ {q}_{n , i} \frac{\partial ln {ϕ}_{{d}_{n}} ( {Δ}_{n , i} )}{\partial {β}_{k}} - {A}_{{d}_{n} , {d}_{i}} \frac{\partial {h}_{n , i}}{\partial {β}_{k}} \} - {v}_{μ} {β}_{k} , \qquad ( 31 )$$

where (n, i) runs over n=1, . . . , N and i=1, . . . , n−1. Similarly to the μ case, we also define

$${N}_{k}^{β} = {\sum }_{( n , i )} {δ}_{{d}_{n} , k} {q}_{n , i} = {\sum }_{n = 1}^{N} {δ}_{{d}_{n} , k} ( 1 - {q}_{n , n} ) , \qquad ( 32 )$$

$${D}_{k}^{β} = {\sum }_{( n , i )} {δ}_{{d}_{n} , k} \{ {A}_{k , {d}_{i}} \frac{\partial {h}_{n , i}}{\partial {β}_{k}} - {q}_{n , i} \frac{{φ}^{′} ( {β}_{k} {Δ}_{n , i} )}{φ ( {β}_{k} {Δ}_{n , i} )} \} . \qquad ( 33 )$$

The optimality condition

$$\frac{\partial L}{\partial {β}_{k}} = 0$$

again becomes a quadratic equation

Nₖ^{β}−Dₖ^{β}βₖ−v_{β}βₖ²=0, (34)

leading to the solution

$${β}_{k} = \frac{1}{2 {v}_{β}} ( - {D}_{k}^{β} + \sqrt{{( {D}_{k}^{β} )}^{2} + 4 {v}_{β} {N}_{k}^{β}} ) . \qquad ( 35 )$$

Estimation of the Impact Matrix A with Cardinality Regularization:

Now, let us discuss how to find A. In equation (24), the objective function L with respect to A can be rewritten as

$${\sum }_{k , l = 1}^{N} ( {Q}_{k , l} ln {A}_{k , l} - {H}_{k , l} {A}_{k , l} ) - \frac{{v}_{A}}{2} {‖ A ‖}_{F}^{2} - τ {‖ A ‖}_{0} , \qquad ( 36 )$$

where we define matrices Q and H by

$${Q}_{k , l} {=}^{Δ} {\sum }_{( n , i )} {δ}_{{d}_{n} , k} {δ}_{{d}_{i} , l} {q}_{n , i} , \qquad ( 37 )$$

$${H}_{k , l} {=}^{Δ} {\sum }_{( n , i )} {δ}_{{d}_{n} , k} {δ}_{{d}_{i} , l} {h}_{n , i} . \qquad ( 38 )$$

For ease of deposition, by defining

x [symbol] vec A, (39)

h [symbol] vec H, (40)

q [symbol] vec Q, (41)

we consider the vectorized version of the problem

$${max}_{x} \{ {\sum }_{m} ( {q}_{m} ln {x}_{m} - {h}_{m} {x}_{m} ) - τ {‖ x ‖}_{0} - \frac{{v}_{A}}{2} {‖ x ‖}_{2}^{2} \} , \qquad ( 42 )$$

where qₘ≥0, hₘ≥0, v_{A}>0 hold. This is the main problem we consider in the estimation of the impact matrix A with cardinality regularization.

Before getting into the details, let us look at what would happen if we instead used the popular l₁ or l_{2,1} regularizer here. The MM procedure is iterative. To make all the instances eligible for candidacy for event consolidation, we need to start with an initialization qₘ≥0. In this case, xₘ=0 cannot be a solution due to the term ln xₘ, and thus sparsity will not be achieved. In other words, the MM algorithm is not compatible with the standard sparse regularizers.

This is reminiscent of the issue with mixture models as discussed by Phan et al. (l₀-regularized sparsity for probabilistic mixture models. In Proc. SIAM Intl. Conf. Data Mining, SIAM, 2019). Here, we leverage their notion of “ε-sparsity”. We introduce a small constant ε>0 for the judgement of sparsity, which can be intuitively understood as the threshold below which an element is “turned off.” Now our problem is

$${x}^{*} = {max}_{x} \{ {Ψ}_{m} ( {x}_{m} ) - τ I ( {x}_{m} \geq ϵ ) \} \qquad ( 43 )$$

$${Ψ}_{m} ( {x}_{m} ) {=}^{Δ} ( {q}_{m} ln {x}_{m} - {h}_{m} {x}_{m} - \frac{{v}_{A}}{2} {x}_{m}^{2} ) , \qquad ( 44 )$$

where I(·) is an indicator function that returns 1 when the argument is true and 0 otherwise. We solve the problem for each k and each value of m=D²−∥x∥₀. Let 0 be the set of indexes that satisfy xₘ≤ϵ. Now, the problem is written as

$${max}_{x} {\sum }_{m} {Ψ}_{m} ( {x}_{m} ) + τ m s . t . ε - {x}_{m} \geq 0 , m ∈ 𝒪 . \qquad ( 45 )$$

With a Lagrange multiplier ξₘ, the Karush-Kuhn-Tucker (KKT) condition is given by

$$\begin{matrix}\frac{{q}_{m}}{{x}_{m}} - {h}_{m} - {v}_{A} {x}_{m} - {ξ}_{m} = 0 , & m ∈ 𝒪 ,\end{matrix} \qquad ( 46 )$$

$$\begin{matrix}{ξ}_{m} ( ε - {x}_{m} ) = 0 , & ε \geq 0 , & {ξ}_{m} = 0 , & m ∈ 𝒪 ,\end{matrix} \qquad ( 47 )$$

$$\begin{matrix}\frac{{q}_{m}}{{x}_{m}} - {h}_{m} - {v}_{A} {x}_{m} = 0 , & m ∉ 𝒪\end{matrix} . \qquad ( 48 )$$

For m∉ [symbol] , we solve equation (48) to get

$${x}_{m}^{*} = {\overline{x}}_{m} , \qquad ( 49 )$$

$$where$$

$$\begin{matrix}{\overline{x}}_{m} {=}^{Δ} \frac{1}{2 {v}_{A}} ( - {h}_{m} + \sqrt{{h}_{m}^{2} + 4 {v}_{A} {q}_{m}} ) , & m ∉ 𝒪\end{matrix} . \qquad ( 50 )$$

For m∈ [symbol] , there are two possibilities:

xₘ*=min(ϵ,x̅ₘ),m∈ [symbol] . (51)

The final question is how to choose the set [symbol] . This can be easily done by computing

ΔΨₘ [symbol] ₘ(ϵ)−Ψₘ(x̅ₘ)+τ (52)

for ∀m. Since Δψₘ is viewed as the gain to turn off xₘ, we put m into [symbol] whenever ΔΨₘ>0.

The algorithm for estimation of the impact matrix A with cardinality regularization is used as part of the iterative MM procedure in equation (24). The total complexity is [symbol] (N²+D²), which is the same as for the existing MM algorithm. For input parameters, ε can be determined by the intuition of it being a threshold for turning off. For τ, we note that equation (36) can be viewed as MAP (maximum a posteriori) estimation with the Bernoulli prior (1−γ)^{∥A∥}^{₀}γ^{D}^{²}^{-∥A∥}^{ₒ}, where γ is the probability of getting 0 in the matrix elements, from which we have

$$τ = \frac{1}{2} ln \frac{γ}{1 - γ} .$$

A value of user's choice in 0.5<γ<1 determines τ. In the iterative MM procedure in equation (24), the parameters v_{A}, v_{β}, and v_{μ}, and are critical for stable convergence. It is recommended to start with a small positive value, such as 10⁻⁵, and increase it if numerical issues occur. The parameters should eventually be cross-validated with independent episodes of event data. If validation dataset is unavailable, the use of Akaike's information criterion (AIC) can be one viable approach, given that ∥A∥₀ approximates the total number of free parameters fitted. Table 1 summarizes L₀Hawkes, the proposed algorithm, which is used as part of the iterative MM procedure in equation (24).

TABLE 1
Algorithm for estimating impact matrix A with cardinality regularization

| | |
|---|---|
| 1: | Input: q = vec Q, h = vec H, ν_{A} > 0, τ ≥ 0, ϵ > 0 |
| 2: | for all m = 1,..., D² do |
| 3: | compute x̅ₘ with equation (50) |
| 4: | compute ΔΨₘ with equations (44) and (52) |
| 5: | if ΔΨₘ > 0 then |
| 6: | xₘ^{*} = min(ϵ, x̅ₘ) (∵ m ∈ [symbol] ) |
| 7: | else |
| 8: | xₘ^{*} = x̅ₘ (∵ m ∉ [symbol] ) |
| 9: | end if |
| 10: | end for |
| 11: | return A^{*} = vec⁻¹x^{*} (convert back to matrix) |

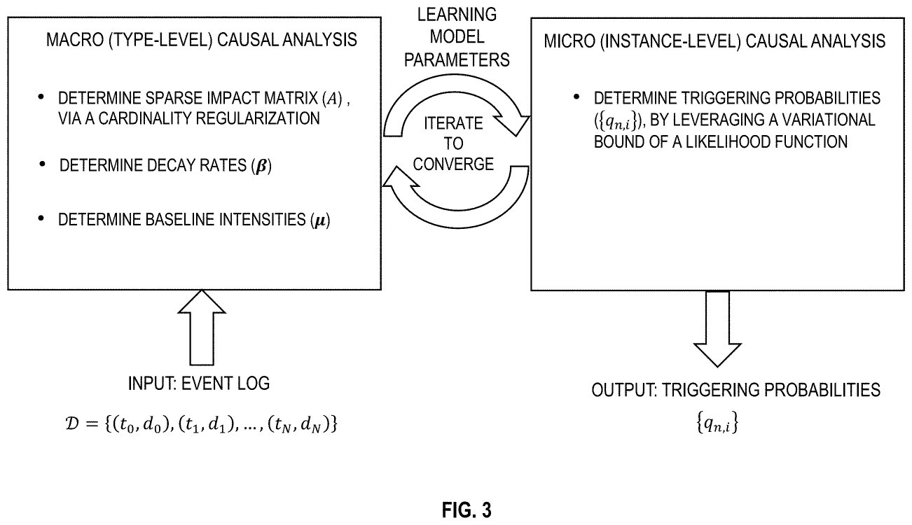

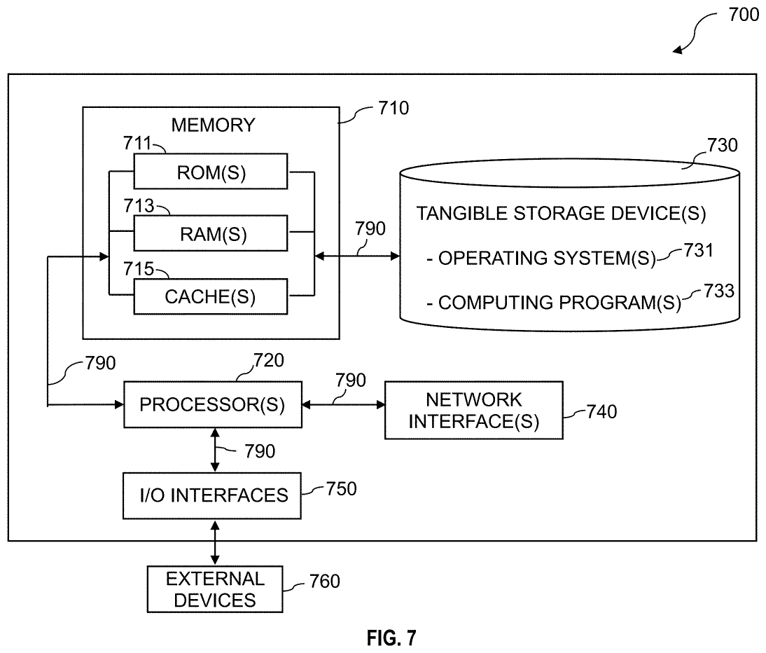

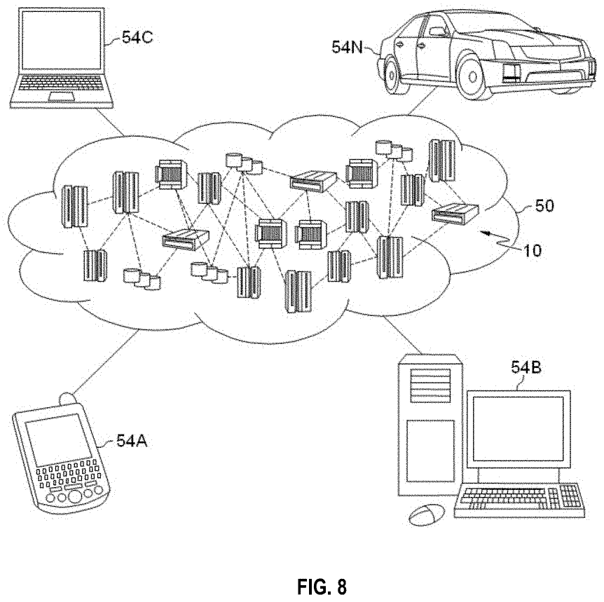

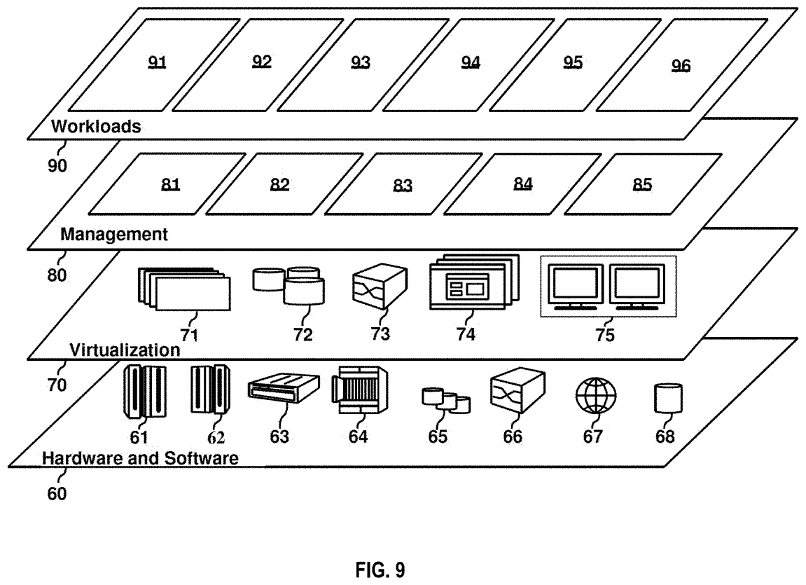

FIG. 3 illustrates an overall computational procedure of the proposed framework in the present invention, in accordance with one embodiment of the present invention. The computational procedure of the proposed framework is implemented by a computing device or server. A computing device or server is described in more detail in later paragraphs with reference to FIG. 7. In some embodiments, the operational steps may be implemented in a cloud computing environment. The cloud computing environment is described in later paragraphs with reference to FIG. 8 and FIG. 9.

Referring to FIG. 3, the computing device or server receives an event log as an input. The event log includes N+1 event instances: [symbol] ={(t₀, d₀), (t₁, d₁), . . . , (t_{N}, d_{N})} where tₙ is the timestamp and dₙ is the event type of the n-th event.

Further referring to FIG. 3, the computing device or server performs macro (type-level) causal analysis. The computing device or server determines the causal relationships between the various event types through the macro (type-level) causal analysis. The impact matrix A gives causal relationships between event types. Achieving sparsity in the impact matrix A is of critical importance in event triage; therefore, the computing device or server determines a sparse impact matrix (A), via a cardinality regularization.

Further referring to FIG. 3, in the macro (type-level) causal analysis, the computing device or server determines decay rates (β). β represents decay rates of respective ones of D event types {1, 2, . . . , D} and provides information about the time scales of the respective ones of the D event types.

Further referring to FIG. 3, in the macro (type-level) causal analysis, the computing device or server determines baseline intensities (μ). μ represents the baseline intensities of the respective ones of the D event types. The baseline intensities (μ) provide information about how each of the D event types has the tendency of occurring on its own without any triggering events.

Further referring to FIG. 3, the computing device or server performs micro (instance-level) causal analysis. The computing device or server determines the causal association probabilities between individual event instances. Triggering probabilities quantify instance-wise causal relationship for event triage. The computing device or server determines triggering probabilities {q_{n,i}}, by leveraging a variational bound of a likelihood function. Two main outcomes of the proposed framework are the instance triggering probabilities {q_{n,i}} and the impact matrix A. The simultaneous instance- and type-level causal analyses are achieved, as a practical solution for event triage. The computing device or server provides triggering probabilities {q_{n,i}} as an output. Triggering probabilities {q_{n,i}} is provided to an end user for event triage. A typical use-case is event filtering which enhances an existing monitoring system. In an example of managing a computer system, an end user realizes that there is something wrong in the system and then checks the triggering probabilities for an event of interest.

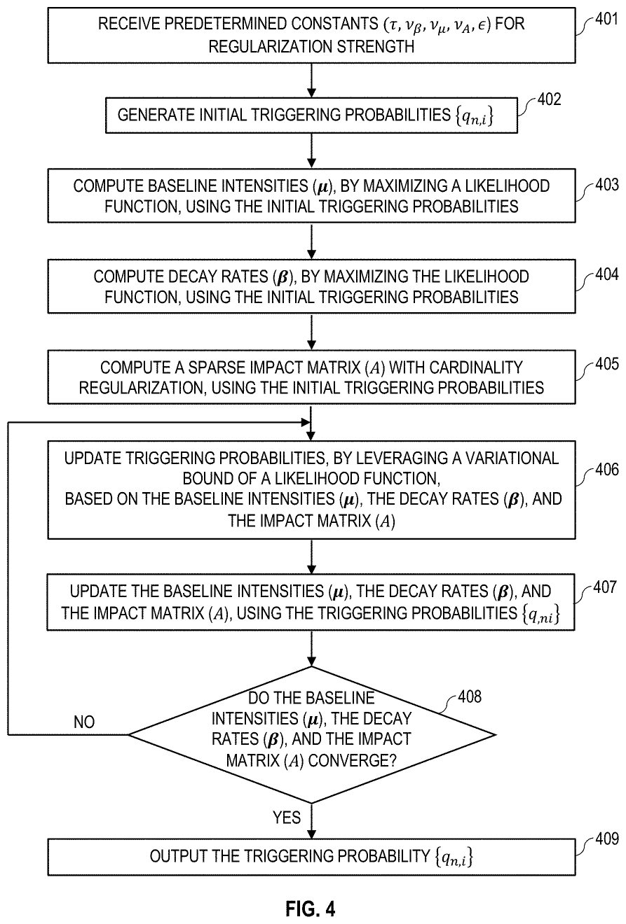

Further referring to FIG. 3, the computing device or server learns model parameters, including the baseline intensities μ, the decay rates β, and the impact matrix A, by iterating the macro (type-level) causal analysis and the micro (instance-level) causal analysis. The computing device or server iterates the analyses until the baseline intensities μ, the decay rates β, and the impact matrix A converge. Operational steps of learning model parameters will be discussed in later paragraphs with reference to FIG. 4.

FIG. 4 presents a flowchart showing operational steps of learning model parameters and determining triggering probabilities based on the model parameters, in accordance with one embodiment of the present invention. The operational steps shown in FIG. 4 are implemented by a computing device or server. A computing device or server is described in more detail in later paragraphs with reference to FIG. 7. In some embodiments, the operational steps may be implemented in a cloud computing environment. The cloud computing environment is described in later paragraphs with reference to FIG. 8 and FIG. 9.

At step 401, the computing device or server receives predetermined constants (τ, v_{β}, v_{μ}, v_{A}, ϵ) for regularization strength. The predetermined constants τ, v_{β}, v_{μ}, v_{A}, ϵ have been discussed in previous paragraphs, and examples of their values are presented in later paragraphs with reference to real use-cases.

At step 402, the computing device or server generates initial triggering probabilities {q_{n,i}}. For example, a lower-triangular matrix is randomly generated using chi-squared distribution (for positivity), and then lower-triangular matrix is normalized such that a summation over each row becomes 1.

At step 403, the computing device or server computes baseline intensities (μ), by maximizing a likelihood function, using the initial triggering probabilities {q_{n,i}}. Based on the initial triggering probabilities {q_{n,i}}, the baseline intensities (μ) of respective ones of event types can be computed using equation (30). In computing the baseline intensities (μ), the likelihood function is maximized.

At step 404, the computing device or server computes decay rates (β), by maximizing the likelihood function, using the initial triggering probabilities {q_{n,i}}. Based on the initial triggering probabilities {q_{n,i}}, the decay rates (β) of respective ones of the event types can be computed using equation (35). In computing the decay rates (β), the likelihood function is maximized.

At step 405, the computing device or server computes a sparse impact matrix (A) with cardinality regularization, using the initial triggering probabilities {q_{n,i}}. Based on the initial triggering probabilities {q_{n,i}}, the sparse impact matrix (A) is computed by using the algorithm presented in Table 1.

It should be appreciated that steps 403-405 are not required to be executed in such a sequential order described above. Steps 403-405 may be executed in different orders other than the above mentioned order or may be executed simultaneously. The order of computing the baseline intensities (μ), the decay rates (β), and the impact matrix (A) may be re-arranged. The computation of the baseline intensities (μ), the decay rates (β), and the impact matrix (A) may be done in one step.

At step 406, the computing device or server updates triggering probabilities {q_{n,i}}, by leveraging a variational bound of a likelihood function, based on the baseline intensities (μ), the decay rates (β), and the impact matrix (A). Once the baseline intensities (μ), the decay rates (β), and the impact matrix (A) are estimated, the triggering probabilities {q_{n,1}} can be updated by using equation (19).

At step 407, the computing device or server updates the baseline intensities (μ), the decay rates (β), and the impact matrix (A), using the triggering probabilities updated at step 406. Similar to steps 403-405, the baseline intensities (μ) of respective ones of event types are updated by using equation (30), the decay rates (β) of respective ones of the event types are updated by using equation (35), and the sparse impact matrix (A) is updated by using the algorithm presented in Table 1.

At step 408, the computing device or server determines whether the baseline intensities (μ), the decay rates (β), and the impact matrix (A) converge. The convergence of the baseline intensities (μ), the decay rates (β), and the impact matrix (A) are determined by comparing the baseline intensities (μ), the decay rates (β), and the impact matrix (A) obtained in a previous round of computation and those obtained in a current round of computation.

In response to determining that the baseline intensities (μ), the decay rates (β), and the impact matrix (A) do not converge (NO branch of decision block 408), the computing device or server iterates step 406. In response to determining that the baseline intensities (μ), the decay rates (β), and the impact matrix (A) converge (YES branch of decision block 408), at step 409, the computing device or server outputs the triggering probabilities {q_{n,i}}, providing a user with the triggering probabilities for event triage.

We validated the proposed framework with two real use-cases, one from the power grid and another from a cloud data center. Our focus was to demonstrate how the proposed framework (L₀Hawkes) advanced the MM algorithm in comparison to existing approaches and to show its utility in real-world use-cases. We compared L₀Hawkes with two known MM-based sparse inference methods: l₁-regularization based (by Zhou et al., 2013) and l_{2,1}-regularization based (by Xu et al., 2016).

In the first real use-case, collaborating with public and private entities, we obtained failure event data of a U.S. power grid. The failure events represented abrupt changes in the voltage and/or current signals measured with phasor measurement units (PMUs), which were deployed in geographically distributed locations in the power grid. We were interested in discovering a hidden causal relationship in a data-driven manner from the temporal event data alone.

The dataset recorded N=3811 failure events labeled as “line outages” from D=22 PMUs over a 10-month period in 2016. We grid-searched the model parameters based on AIC to get 5×(10⁻³, 10⁻⁴, 10⁻⁴) for (v_{μ}, v_{β}, μ_{A}) and (1,1) for (τ, ε). The value of ε corresponded to about 3% of max_{k,l} A_{k,l}. We used the same τ for the l₁ and l_{2,1} regularizers. We used the power decay of η=2 to capture long-tail behaviors.

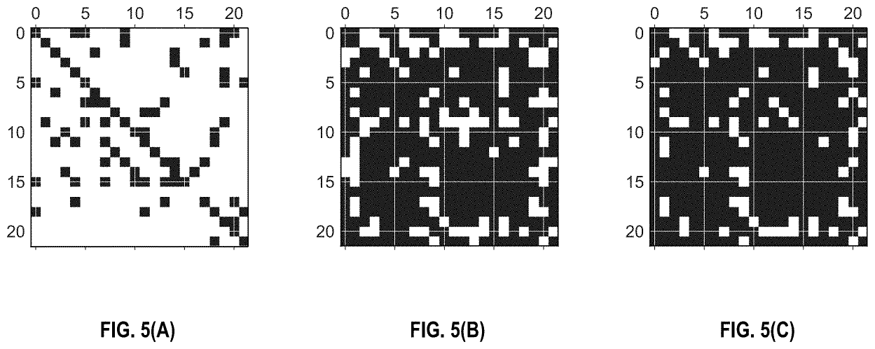

FIG. 5(A) shows a sparsity pattern of estimated impact matrix A with L₀Hawkes, FIG. 5(B) shows a sparsity pattern of estimated impact matrix A with the l₁-regularizer, and FIG. 5(C) shows a sparsity pattern of estimated impact matrix A with the l_{2,1}-regularizer. These figures compare computed A, in which nonzero matrix elements are shown in black. With the l₁ and l_{2,1} regularizers, zero entries can appear only when Q_{k.l} happens to be numerically zero. In contrast, L₀Hawkes enjoys guaranteed sparsity. From the computed A, a hidden causal structure among PMUs were successfully discovered.

In the second real use-case, we applied L₀Hawkes to a real event triage task. We obtained N=718 warning events from a real cloud data center management system. These events resulted from filtering logs emitted by network devices and each has its type: there were D=14 unique event types in our dataset. In this real use-case, we focused on showing examples of instance-level causal analysis.

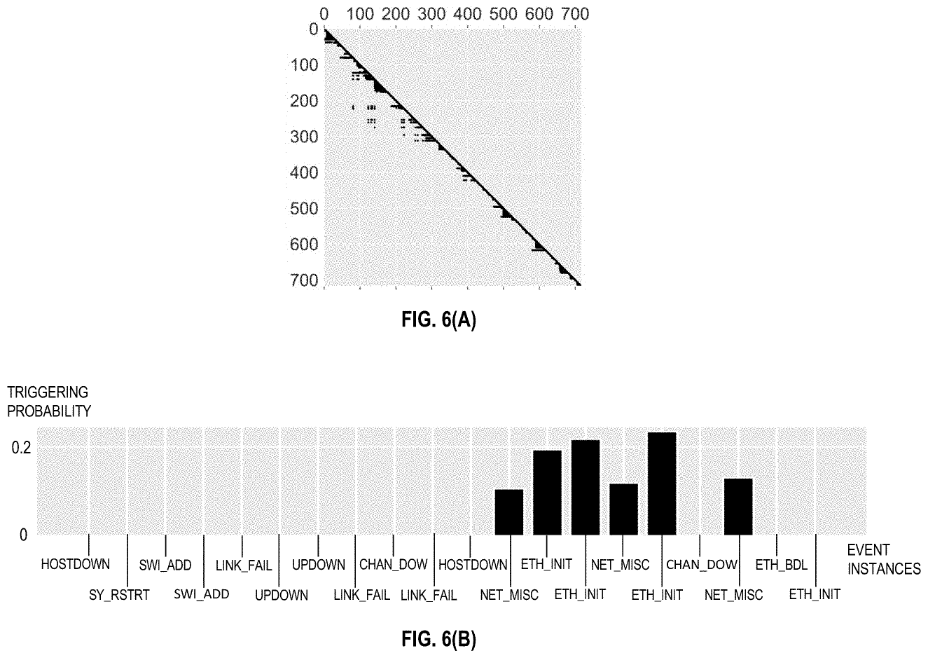

FIG. 6(A) visualizes nonzero entries of instance triggering probabilities {q_{n,i}}, where those with q_{n,i}<0.01 are omitted. As expected, {q_{n,i}} is quite sparse and hence event consolidation can be straightforwardly performed by picking nonzero triggering probabilities. FIG. 6(B) shows an example of q_{150,i}, in which the rightmost slot (ETH_INIT) corresponds to the self probability q_{150,150}. For each i, its event type dᵢ is shown below the bar. The type of the event in question, ETH_INIT, is related to the process of initializing an Ethernet interface. Note in FIG. 6(B) that the self probability of this instance was computed as 0, while several preceding instances of the same type had positive triggering probabilities, leading to successful suppression of duplication.

Many instances had zero triggering probability despite their time proximity (the six events with positive probabilities were within 27 seconds from the 150th event), thanks to the sparsity of A. For example, this dataset contained 416 instances of event type UPDOWN adding considerable noise but were appropriately ignored by the proposed platform L₀Hawkes. Unlike naive hard-windowing approaches, our framework was able to sift for genuine causal relationships.

FIG. 7 is a diagram illustrating components of computing device or server 700, in accordance with one embodiment of the present invention. It should be appreciated that FIG. 7 provides only an illustration of one implementation and does not imply any limitations with regard to the environment in which different embodiments may be implemented.

Referring to FIG. 7, computing device or server 700 includes processor(s) 720, memory 710, and tangible storage device(s) 730. In FIG. 7, communications among the above-mentioned components of computing device or server 700 are denoted by numeral 790. Memory 710 includes ROM(s) (Read Only Memory) 711, RAM(s) (Random Access Memory) 713, and cache(s) 715. One or more operating systems 731 and one or more computer programs 733 reside on one or more computer readable tangible storage device(s) 730.

Computing device or server 700 further includes I/O interface(s) 750. I/O interface(s) 750 allows for input and output of data with external device(s) 760 that may be connected to computing device or server 700. Computing device or server 700 further includes network interface(s) 740 for communications between computing device or server 700 and a computer network.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the C programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 8, illustrative cloud computing environment 50 is depicted. As shown, cloud computing environment 50 includes one or more cloud computing nodes 10 with which local computing devices are used by cloud consumers, such as mobile device 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N are intended to be illustrative only and that computing nodes 10 and cloud computing environment 50 can communicate with any type of computerized device over any type of network and/or network addressable connection (e.g., using a web browser).

Referring now to FIG. 9, a set of functional abstraction layers provided by cloud computing environment 50 (FIG. 8) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and function 96. Function 96 in the present invention is the functionality of stochastic event triage for artificial intelligence for information technology operations (AIOps) in a cloud computing environment.

What is claimed is:

1. A computer-implemented method for stochastic event triage, the computer-implemented method comprising:
receiving an event log including timestamps and event types;
determining a sparse impact matrix representing causal relationships between the event types, via a cardinality regularization;
determining triggering probabilities representing causal association probabilities between individual event instances, by leveraging a variational bound of a likelihood function; and
providing a user with the triggering probabilities for event triage.

2. The computer-implemented method of claim 1, further comprising:
determining baseline intensities of respective ones of the event types, wherein the baseline intensities provide information about how each of the event types has a tendency of occurring on its own without any triggering event; and
determining decay rates of the respective ones of the event types, wherein the decay rates provide information about time scales of the respective ones of the event types.

3. The computer-implemented method of claim 1, further comprising:
learning model parameters by iterating type-level causal analysis and instance-level causal analysis;
wherein the type-level causal analysis includes determining the sparse impact matrix, baseline intensities of respective ones of the event types, and decay rates of respective ones of the event types, wherein the baseline intensities provide information about how each of the event types has a tendency of occurring on its own without any triggering event, wherein the decay rates provide information about time scales of the respective ones of the event types; and
wherein the instance-level causal analysis includes determining the triggering probabilities.

4. The computer-implemented method of claim 3, further comprising:
generating initial triggering probabilities; and
computing the baseline intensities, the decay rates, and the sparse impact matrix, based on the initial triggering probabilities.

5. The computer-implemented method of claim 4, further comprising:
updating, in a current round of computation, the triggering probabilities, based on the baseline intensities, the decay rates, and the sparse impact matrix computed in a previous round of computation;
updating the baseline intensities, the decay rates, and the sparse impact matrix, based on the triggering probabilities that have been updated;
in response to determining that the baseline intensities, the decay rates, and the sparse impact matrix converge, outputting the triggering probabilities that have been updated in the current round of computation; and
in response to determining that the baseline intensities, the decay rates, and the sparse impact matrix do not converge, iterating updating the triggering probabilities, the baseline intensities, the decay rates, and the sparse impact matrix.

6. A computer program product for stochastic event triage, the computer program product comprising a computer readable storage medium having program instructions embodied therewith, the program instructions executable by one or more processors, the program instructions executable to:
receive an event log including timestamps and event types;
determine a sparse impact matrix representing causal relationships between the event types, via a cardinality regularization;
determine triggering probabilities representing causal association probabilities between individual event instances, by leveraging a variational bound of a likelihood function; and
provide a user with the triggering probabilities for event triage.

7. The computer program product of claim 6, further comprising the program instructions executable to:
determine baseline intensities of respective ones of the event types, wherein the baseline intensities provide information about how each of the event types has a tendency of occurring on its own without any triggering event; and
determine decay rates of the respective ones of the event types, wherein the decay rates provide information about time scales of the respective ones of the event types.

8. The computer program product of claim 6, further comprising the program instructions executable to:
learn model parameters by iterating type-level causal analysis and instance-level causal analysis;
wherein the type-level causal analysis includes determining the sparse impact matrix, baseline intensities of respective ones of the event types, and decay rates of respective ones of the event types, wherein the baseline intensities provide information about how each of the event types has a tendency of occurring on its own without any triggering event, wherein the decay rates provide information about time scales of the respective ones of the event types; and
wherein the instance-level causal analysis includes determining the triggering probabilities.

9. The computer program product of claim 8, further comprising the program instructions executable to:
generate initial triggering probabilities; and
compute the baseline intensities, the decay rates, and the sparse impact matrix, based on the initial triggering probabilities.

10. The computer program product of claim 9, further comprising the program instructions executable to:
update, in a current round of computation, the triggering probabilities, based on the baseline intensities, the decay rates, and the sparse impact matrix computed in a previous round of computation;
update the baseline intensities, the decay rates, and the sparse impact matrix, based on the triggering probabilities that have been updated;
in response to determining that the baseline intensities, the decay rates, and the sparse impact matrix converge, output the triggering probabilities that have been updated in the current round of computation; and
in response to determining that the baseline intensities, the decay rates, and the sparse impact matrix do not converge, iterate updating the triggering probabilities, the baseline intensities, the decay rates, and the sparse impact matrix.

11. A computer system for stochastic event triage, the computer system comprising:
one or more processors, one or more computer readable tangible storage devices, and program instructions stored on at least one of the one or more computer readable tangible storage devices for execution by at least one of the one or more processors, the program instructions executable to:
receive an event log including timestamps and event types;
determine a sparse impact matrix representing causal relationships between the event types, via a cardinality regularization;
determine triggering probabilities representing causal association probabilities between individual event instances, by leveraging a variational bound of a likelihood function; and
provide a user with the triggering probabilities for event triage.

12. The computer system of claim 11, further comprising the program instructions executable to:
determine baseline intensities of respective ones of the event types, wherein the baseline intensities provide information about how each of the event types has a tendency of occurring on its own without any triggering event; and
determine decay rates of the respective ones of the event types, wherein the decay rates provide information about time scales of the respective ones of the event types.

13. The computer system of claim 11, further comprising the program instructions executable to:
learn model parameters by iterating type-level causal analysis and instance-level causal analysis;
wherein the type-level causal analysis includes determining the sparse impact matrix, baseline intensities of respective ones of the event types, and decay rates of respective ones of the event types, wherein the baseline intensities provide information about how each of the event types has a tendency of occurring on its own without any triggering event, wherein the decay rates provide information about time scales of the respective ones of the event types; and
wherein the instance-level causal analysis includes determining the triggering probabilities.

14. The computer system of claim 13, further comprising the program instructions executable to:
generate initial triggering probabilities; and
compute the baseline intensities, the decay rates, and the sparse impact matrix, based on the initial triggering probabilities.

15. The computer system of claim 14, further comprising the program instructions executable to:
update, in a current round of computation, the triggering probabilities, based on the baseline intensities, the decay rates, and the sparse impact matrix computed in a previous round of computation;
update the baseline intensities, the decay rates, and the sparse impact matrix, based on the triggering probabilities that have been updated;
in response to determining that the baseline intensities, the decay rates, and the sparse impact matrix converge, output the triggering probabilities that have been updated in the current round of computation; and
in response to determining that the baseline intensities, the decay rates, and the sparse impact matrix do not converge, iterate updating the triggering probabilities, the baseline intensities, the decay rates, and the sparse impact matrix.

16. A computer-implemented method for learning model parameters in stochastic event triage, the computer-implemented method comprising:
updating baseline intensities of respective ones of event types, based on triggering probabilities, wherein the baseline intensities provide information about how each of the event types has a tendency of occurring on its own without any triggering event, wherein the triggering probabilities represent causal association probabilities between individual event instances;
updating decay rates of the respective ones of the event types, based on the triggering probabilities, wherein the decay rates provide information about time scales of the respective ones of the event types;
updating a sparse impact matrix, based on the triggering probabilities, wherein the sparse impact matrix represents causal relationships between the event types;
updating the triggering probabilities, based on the baseline intensities, the decay rates, and the sparse impact matrix; and
providing a user with the triggering probabilities for event triage, in response to determining that the baseline intensities, the decay rates, and the sparse impact matrix converge.

17. The computer-implemented method of claim 16, further comprising:
receiving predetermined constants for regularization strength;
generating initial triggering probabilities; and
computing the baseline intensities, the decay rates, and the sparse impact matrix, based on the initial triggering probabilities.

18. The computer-implemented method of claim 16, further comprising:
in response to determining that the baseline intensities, the decay rates, and the sparse impact matrix do not converge, iterating updating the baseline intensities, the decay rates, the sparse impact matrix converge, and the triggering probabilities.

19. The computer-implemented method of claim 16, wherein the baseline intensities and the decay rates are updated by maximizing a likelihood function, wherein the sparse impact matrix converge is updated via a cardinality regularization.

20. The computer-implemented method of claim 16, wherein the triggering probabilities is updated by leveraging a variational bound of a likelihood function.

21. A computer program product for learning model parameters in stochastic event triage, the computer program product comprising a computer readable storage medium having program instructions embodied therewith, the program instructions executable by one or more processors, the program instructions executable to:
update baseline intensities of respective ones of event types, based on triggering probabilities, wherein the baseline intensities provide information about how each of the event types has a tendency of occurring on its own without any triggering event, wherein the triggering probabilities represent causal association probabilities between individual event instances;
update decay rates of the respective ones of the event types, based on the triggering probabilities, wherein the decay rates provide information about time scales of the respective ones of the event types;
update a sparse impact matrix, based on the triggering probabilities, wherein the sparse impact matrix represents causal relationships between the event types;
update the triggering probabilities, based on the baseline intensities, the decay rates, and the sparse impact matrix; and
provide a user with the triggering probabilities for event triage, in response to determining that the baseline intensities, the decay rates, and the sparse impact matrix converge.

22. The computer program product of claim 21, further comprising the program instructions executable to:
receive predetermined constants for regularization strength;
generate initial triggering probabilities; and
compute the baseline intensities, the decay rates, and the sparse impact matrix, based on the initial triggering probabilities.

23. The computer program product of claim 21, further comprising the program instructions executable to:
in response to determining that the baseline intensities, the decay rates, and the sparse impact matrix do not converge, iterate updating the baseline intensities, the decay rates, the sparse impact matrix converge, and the triggering probabilities.

24. The computer program product of claim 21, wherein the baseline intensities and the decay rates are updated by maximizing a likelihood function, wherein the sparse impact matrix converge is updated via a cardinality regularization.

25. The computer program product of claim 21, wherein the triggering probabilities is updated by leveraging a variational bound of a likelihood function.
